(19) United States
(12) Patent Application Publication
(10) Pub. No.: US 2015/0011265 A1
(43) Pub. Date: Jan. 8, 2015

(54) Support Apparatus for Mobile Device

(71) Applicant: James A. Walsh, JR., Topeka, KS (US)

(72) Inventor: James A. Walsh, JR., Topeka, KS (US)

(21) Appl. No.: 14/319,496

(22) Filed: Jun. 30, 2014

Related U.S. Application Data
(60) Provisional application No. 61/843,120, filed on Jul. 5, 2013.

(51) Int. Cl. H04M 1/05

(52) U.S. Cl. CPC H04M 1/05
USPC 455/569.1

(57) ABSTRACT

An adjustable head and shoulder support apparatus for use with a mobile phone includes a mobile device case having opposing top and bottom ends and configured to hold the mobile phone, the case including a rear face. The apparatus includes a support arm having a first end pivotally coupled to the rear face proximate the top end and a second end opposed from the first end. The support arm is pivotally movable between a stowed configuration adjacent the rear face and an extended configuration displaced from the rear face. The rear face of the case defines a recess that includes an upper portion having a generally circular configuration and a lower portion in communication with the upper portion. The support arm is nested in the lower portion of the recess at the stowed configuration and is displaced from the lower portion of the recess at the extended configuration.

### CROSS REFERENCE TO RELATED APPLICATION

This patent application claims the priority of U.S. Provisional Patent Application No. 61/842,160 filed on Jul. 2, 2013 titled “Mobile Device Head and Shoulder Rest Support System” which is incorporated by reference in its entirety herein.

### BACKGROUND OF THE INVENTION

This invention relates generally to mobile phone support devices and, more particularly, to an adjustable neck and shoulder support apparatus for use with a mobile device case that reduces neck and shoulder pain experienced by a user operating a mobile device.

The number of people using mobile devices is increasing rapidly throughout the world. The most popular of these devices include smart phones. It is a common problem for users to experience neck and shoulder pain when a mobile device is held between their ears and shoulder for an extended period of time. This pain is caused by the users' cramping of their shoulder and neck muscles due to inadequate head and shoulder support when operating the mobile device.

There are limited and ineffective options for minimizing a user's pain when operating a mobile device. Current cellular phone head and shoulder rests are cumbersome and have to be removed from the cellular phone itself. Making use of such devices is impractical and often inaccessible. Alternative systems in the field include headsets and Bluetooth devices. However, these headsets and Bluetooth devices have limitations because they are not always readily accessible when a call needs to be placed unless they are stowed with the mobile device. Further, these devices are cumbersome because they require batteries that need to be charged, have to be turned on and synced with a specific phone, and they can interfere with a call's sound quality.

Therefore, it would be desirable to have an adjustable head and shoulder rest support system that is conveniently built into the mobile device case, which ensures that users will have the support system and case available anytime they want to operate the mobile device. Further, it would be desirable to have an adjustable head and shoulder rest support system that allows users to operate a mobile device in a hands-free manner while minimizing the chance they will experience neck and shoulder pain.

### SUMMARY OF THE INVENTION

An adjustable head and shoulder support apparatus for use with a mobile phone in order to reduce neck and shoulder pain experienced by a user operating a mobile device includes a mobile device case having a top end and an opposed bottom end and configured to hold the mobile phone, the case including a rear face extending between the top and bottom ends. The apparatus includes a support arm having a first end pivotally coupled to the rear face proximate the top end and having a second end opposed from the first end. The support arm is pivotally movable between a stowed configuration adjacent the rear face of the case and an extended configuration displaced from the rear face. The rear face of the case defines a recess that includes an upper portion having a generally circular configuration and a lower portion in communication with the upper portion. The support arm is nested in the lower portion of the recess at the stowed configuration and is displaced from the lower portion of the recess at the extended configuration.

Therefore, a general object of this invention is to provide an adjustable head and shoulder support apparatus for use with a mobile phone in order to reduce neck and shoulder pain experienced by a user operating a mobile device

Another object of this invention is to provide an adjustable head and shoulder support apparatus, as aforesaid, that is integrated or coupled to a mobile device case so that it is always available to a user when needed.

Still another object of this invention is to provide an adjustable head and shoulder support apparatus, as aforesaid, that includes a support arm pivotally coupled to a rear face of the mobile device case and movable between a stowed configuration adjacent the rear face and an extended configuration displaced from said rear face.

Yet another object of this invention is to provide an adjustable head and shoulder support apparatus, as aforesaid, in which the rear face has a recessed area configured to receive the support arm at the stowed configuration.

A further object of this invention is to provide an adjustable head and shoulder support apparatus, as aforesaid, in which a second/distal end of the support arm that is configured to fit a profile of a shoulder of a user so as to nest thereon in use.

A still further object of this invention is to provide an adjustable head and shoulder support apparatus, as aforesaid, that is easy to use and easy to adjust.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a top view of an adjustable head and shoulder support apparatus according to an embodiment of the present invention

FIG. 1b is a rear perspective view of the apparatus as in FIG. 1a illustrated with a support arm in a stowed configuration;

FIG. 1c is a front perspective view of the apparatus as in FIG. 1a;

FIG. 1d is a side view of the apparatus as in FIG. 1a;

FIG. 1e is a rear view of the apparatus as in FIG. 1b;

FIG. 2a is a top view of the apparatus as in FIG. 1a illustrating the support arm in an extended configuration;

FIG. 2b is a rear perspective view of the apparatus as in FIG. 2a;

FIG. 2c is a side view of the apparatus as in FIG. 2a;

FIG. 2d is a is a rear view of the apparatus as in FIG. 2b;

FIG. 3a is a top view of the apparatus as in FIG. 2a illustrating the support arm in an extended and rotated configuration;

FIG. 3b is a rear perspective view of the apparatus as in FIG. 3a;

FIG. 3c is a side view of the apparatus as in FIG. 3a;

FIG. 3d is a is a rear view of the apparatus as in FIG. 3b;

FIG. 4a is another rear perspective view of the apparatus as in FIG. 2b;

FIG. 4b is another rear view of the apparatus as in FIG. 3d;

FIG. 4c is a front perspective view of the apparatus as in FIG. 4b; and

FIG. 5 is a perspective view of the apparatus as in FIG. lb with the mobile device removed from the device case.

### DESCRIPTION OF THE PREFERRED EMBODIMENT

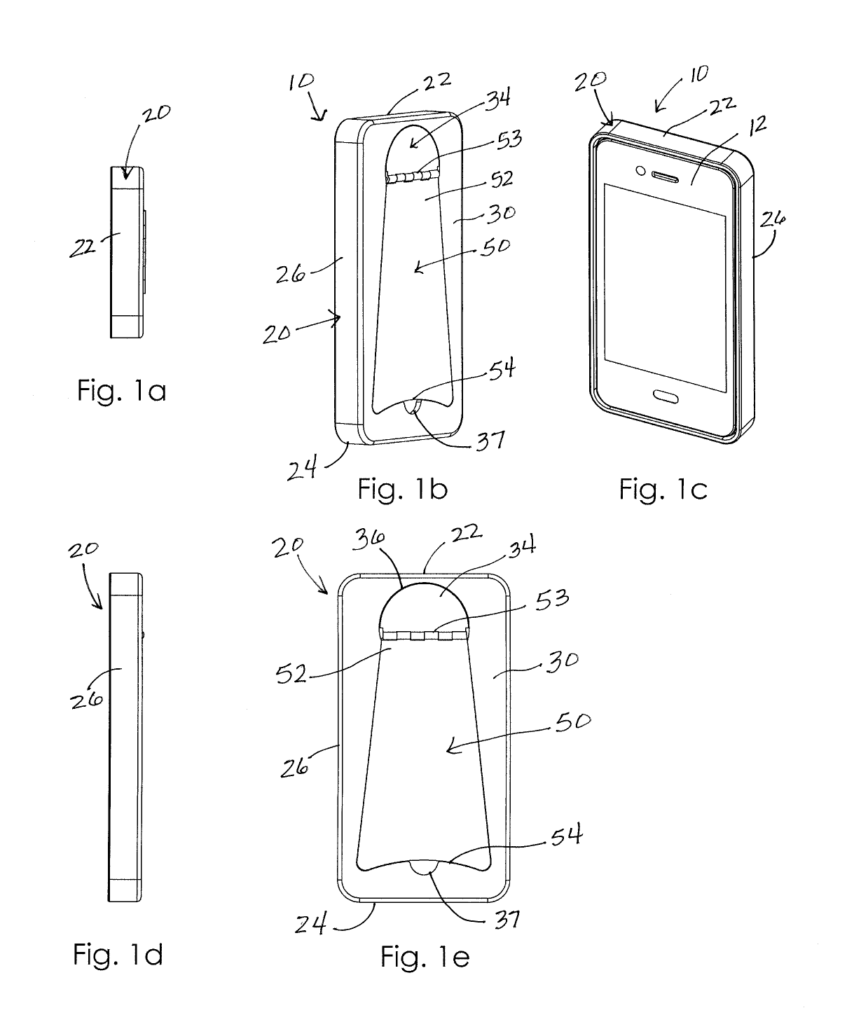

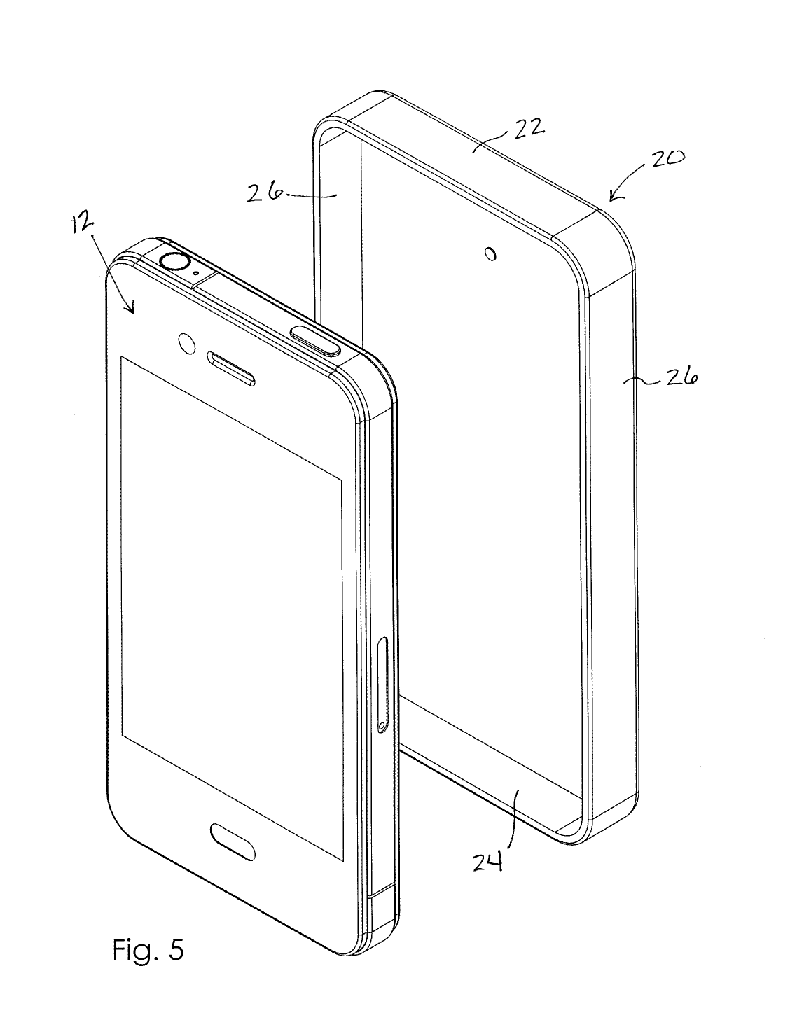

An adjustable head and shoulder support apparatus for use with a mobile device will now be described with reference to FIGS. 1 to 5 of the accompanying drawings. More particularly, the adjustable head and shoulder support apparatus 10 includes a mobile device case 20 and a support arm 50 operatively coupled to the mobile device case 20.

The mobile device case 20 may include opposed top 22 and bottom 24 end walls and side walls 26 extending therebetween so as to form a framework. In an embodiment, the framework may be configured to receive and hold a mobile device 12 such as a cell phone that is otherwise independent of the framework. In another embodiment, the mobile device and framework may have an integrated and unitary construction.

The mobile device case 20 includes a rear face 30 that extends between rear edges of the top 22 and bottom 24 ends and between rear edges of the side walls 26 of the mobile device case 20 (FIG. 1b). In an embodiment, the rear face 30 may have a generally planar configuration (not shown). In another embodiment (shown in the accompanying drawings) the rear face 30 may define a recess 32 configured to receive sections of the support arm 50. The recess 32 includes an upper portion 34 having a generally circular configuration and a lower portion in communication with the upper portion (FIG. 1b). The upper portion 34 includes a peripheral lip 36 in cooperation with the means for coupling an end of the support arm 50 as will be described later.

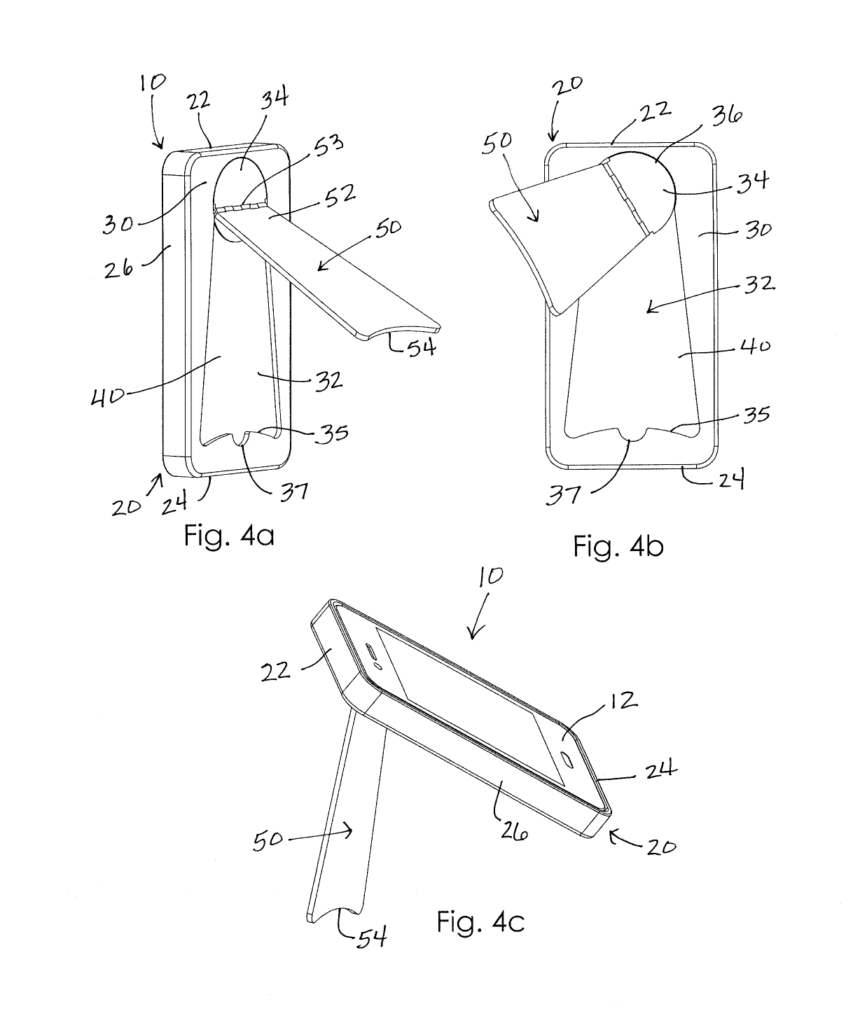

The support arm 50 of the support apparatus 10 includes a first end 52 pivotally coupled to the rear face 30 of the device case 20, such as with a hinge 53, and a second end 54 opposed from the first end 52. In some embodiments, the coupling of the first end of the support arm 50 may be with a traditional hinge, a friction hinge, a spring-loaded hinge, a living hinge, or a detent (FIG. 4a).

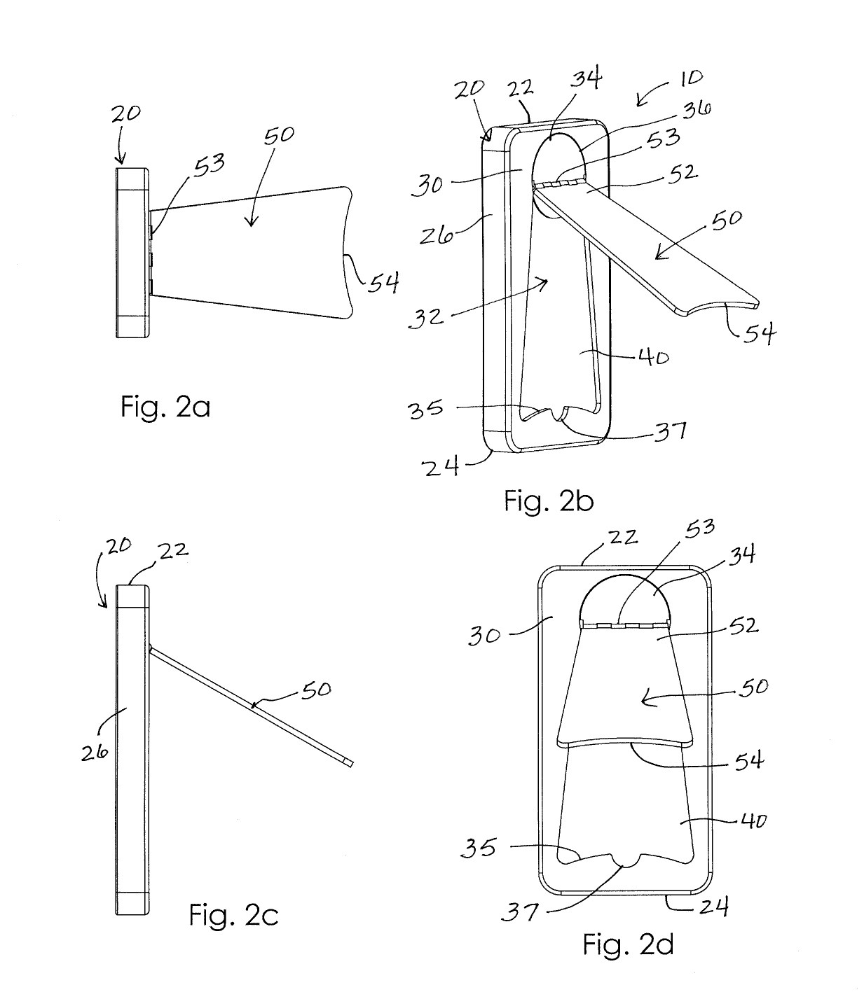

The pivotal connection enables the support arm 50 to move between a stowed configuration adjacent the rear face 30 (FIG. 1b) and an extended configuration displaced from the rear face (FIG. 2b). In an embodiment with the rear face 30 defining a recess 32 as described above, the support arm 50 is configured to nest in the lower portion 40 of the recess 32 when positioned at the stowed configuration (FIG. 1b). In an embodiment, the lower portion of the recess 32 may include a generally rectangular configuration complementary to a generally rectangular configuration of the support arm 50 so as to receive and nest the support arm 50 in the stowed configuration. The support arm 50 includes a generally planer/flat configuration.

In another embodiment, the support arm 50 has a width adjacent the second end 54 that is greater than a width adjacent the first end 52 (FIG. 2b). Similarly, the lower portion 40 of the recess 32 adjacent the bottom end wall 24 of the case 20 is greater than a width of the lower portion 40 of the recess 32 adjacent said upper portion 34 of the recess 32. Stated another way, the width of the recess 32 increases downwardly from its proximity with the upper portion 34 of the recess 32. In this embodiment, the lower portion 40 of the recess 32 is configured to receive the support arm 50 having a complementary configuration in a nested relationship at the stowed configuration (FIG. 1b).

Further, a lower end 35 of the lower portion 40 of the recess 32 may have a generally convex or upwardly arched configuration (FIG. 2d). Conversely, the second end 54 of the support arm 50 may have a generally concave or inwardly arched configuration complementary to the shape of the lower end 35 of the lower portion 40 of the recess 32. Accordingly, the support arm 50 is received into the lower portion 40 of the recess 32 in a nested configuration as described above (FIG. 1b). The concave configuration of the second end 54 of the support arm 50 is complementary to the shape of a person's shoulder so as to selectively mate therewith in use in supporting the case 20 and mobile device 12 thereupon in use.

The rear face 30 may define a notch 37 in communication with the lower end 35 of the lower portion 40 of the recess 32 that is configured to enable a user to insert a finger and move the support arm 50 from the stowed configuration to the extended configuration. In other words, the notch 37 is essentially a finger access hole by which to dislodge the support arm 50 from the stowed configuration (FIG. 1b).

As explained above, the first end 52 of the support arm 50 is pivotally coupled to the rear face 30 at the upper portion 34 of the recess 32 (FIG. 2b). In one embodiment, the first end 52 of the support arm 50 is rotatably coupled to the rear face 30 of the case 20 so as to rotate selectively within the upper portion 34 of the recess 32. Preferably, the first end 52 of the support arm 50 is configured to move at least 90 degrees in either rotational direction. More particularly, the rear face 30 may include a lip 36 surrounding the upper portion 34 of the recess 32 and the first end 52 of the support arm 50 may include a flange situated relative to said lip 36 in a loose friction fit arrangement to facilitate the rotational movement described above. Other structural assemblies that provide for rotational movement may also be used.

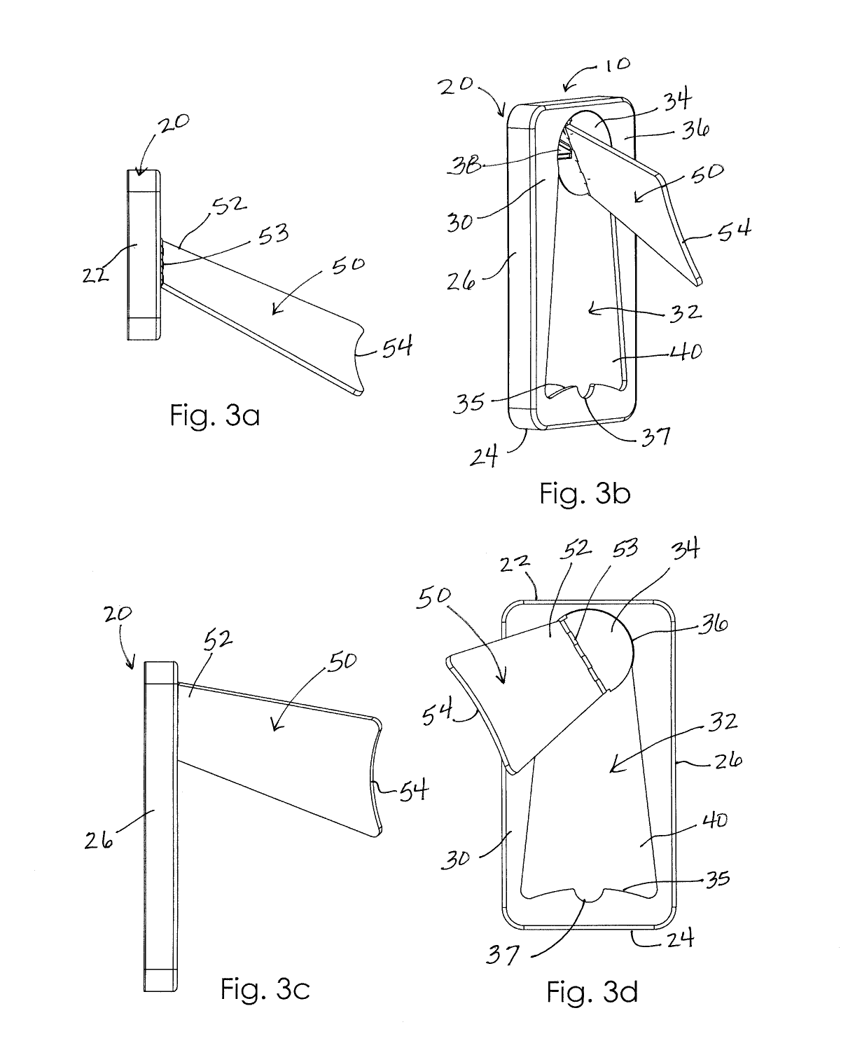

In an embodiment, the rear face 30 may define a slot 38 (FIG. 3b) within the upper portion 34 of the recess 32 configured to receive a guide flange (not shown) extending from the first end 52 of the support arm 50. The slot 38 is configured to frictionally hold the support arm 50 in a primary position aligned with the lower portion 40 of the recess 32 so that the support arm 50 is properly nested therein when pivoted toward the stowed configuration. In use, the support arm 50 may be rotatably moved to the left or right of the lower portion 40 of the recess 32 by rotating the first end 52 of the support arm 50 relative to the slot 38 (FIGS. 3b and 3d).

In use, the support arm 50 is positioned in the stowed configuration (FIG. 1b) when the mobile device 12 is stowed in a user's pocket, purse, desk drawer, etc. or even when the mobile device 12 is used without being situated on his shoulder. However, when shoulder use is desired, the support arm 50 may be pivoted to the extended configuration (FIG. 2b) and positioned between a person's shoulder and ear as described above.

It is understood that the components of the mobile device head and shoulder rest support system described in several embodiments herein may comprise any known materials in the field and be of any color, size and/or dimensions. This allows the system to accommodate any user and mobile device. For example, the mobile device case, support arm, friction hinge, detent mechanism and support layer may comprise any material or combination of materials including, but not limited to, plastics, rubbers, metals, or the like.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

It is understood that while certain forms of this invention have been illustrated and described, it is not limited thereto except insofar as such limitations are included in the following claims and allowable functional equivalents thereof.

1. An adjustable head and shoulder support apparatus for use with a mobile device in order to reduce neck and shoulder pain experienced by a user operating the mobile device, said apparatus, comprising:
a case having a top end and an opposed bottom end and configured to hold the mobile phone, said case including a rear face extending between said top and bottom ends; and
a support arm having a first end pivotally coupled to said rear face proximate said top end and having a second end opposed from said first end;
wherein said support arm is pivotally movable between a stowed configuration adjacent said rear face of said case and an extended configuration displaced from said rear face.

2. The adjustable head and shoulder support apparatus as in claim 1, wherein:
said rear face of said case defines a recess that includes an upper portion having a generally circular configuration and a lower portion in communication with said upper portion;
said first end of said support arm is situated in said upper portion of said recess and is coupled to said rear face with a hinge;
wherein said support arm is nested in said lower portion of said recess at said stowed configuration and is displaced from said lower portion of said recess at said extended configuration.

3. The adjustable head and shoulder support apparatus as in claim 2, wherein:
said support arm has a generally rectangular and planar configuration;
said lower portion of said recess includes a generally rectangular configuration such that said support arm is received in said lower portion when positioned at said stowed configuration.

4. The adjustable head and shoulder support apparatus as in claim 3, wherein said support arm has a width adjacent said second end that is greater than a width adjacent said first end.

5. The adjustable head and shoulder support apparatus as in claim 4, wherein said lower portion of said recess adjacent said bottom end of said case is greater than a width of said lower portion of said recess adjacent said upper portion of said recess.

6. The adjustable head and shoulder support apparatus as in claim 2, wherein said second end of said support arm has a concave configuration adapted to rest on a shoulder of a user.

7. The adjustable head and shoulder support apparatus as in claim 6, wherein said lower portion of said recess includes a configuration complementary to the configuration of said second end of said support arm so as to receive said support arm at said stowed configuration.

8. The adjustable head and shoulder support apparatus as in claim 2, wherein said first end of said support is configured to rotate relative to said upper portion of said recess such that said support arm is selectively positioned extending to the left or to the right relative to said rear face of said case.

9. The adjustable head and shoulder support apparatus as in claim 7, wherein said first end of said support is configured to rotate relative to said upper portion of said recess such that said support arm is selectively positioned extending to the left or to the right relative to said rear face of said case.

10. The adjustable head and shoulder support apparatus as in claim 5, wherein said first end of said support is configured to rotate relative to said upper portion of said recess such that said support arm is selectively positioned extending to the left or to the right relative to said rear face of said case.

11. The adjustable head and shoulder support apparatus as in claim 1, wherein said first end of said support is configured to rotate relative to said rear face of said case such that said support arm is selectively positioned extending to the left or to the right relative to said rear face of said case.

12. The adjustable head and shoulder support apparatus as in claim 1, wherein said case is integrally coupled to the mobile phone.

13. The adjustable head and shoulder support apparatus as in claim 1, wherein said case is configured to releasably receive the mobile device.

14. The adjustable head and shoulder support apparatus as in claim 2, wherein said rear face defines a slot in said upper portion of said recess configured to releasably receive said first end of said support arm.
